(19) United States
(12) Patent Application Publication
(10) Pub. No.: US 2012/0005577 A1
(43) Pub. Date: Jan. 5, 2012

(54) Building Mashups on Touch Screen Mobile Devices

(75) Inventors: Al Chakra, Apex, NC (US); John K. Gerken, III, Apex, NC (US); Ruthie D. Lyle, Durham, NC (US); Steven M. Miller, Cary, NC (US)

(73) Assignee: INTERNATIONAL BUSINESS MACHINES CORPORATION, Armonk, NY (US)

(21) Appl. No.: 12/827,340

(22) Filed: Jun. 30, 2010

(51) Int. Cl. G06F 3/048; G06F 15/16; G06F 3/01

(52) U.S. Cl. 715/702; 715/769; 709/217; 715/853

(57) ABSTRACT

Systems and methods of constructing mashups may involve receiving a mashup creation input via a touch screen of a mobile device. A mashup can be built based on the mashup creation input, wherein the mashup is presented to a user via the touch screen. In one example, the mashup creation input includes a selection of an icon associated with a widget.

### BACKGROUND

1. Technical Field

Embodiments of the present invention generally relate to mashups. More particularly, embodiments relate to the construction and consumption of mashups on mobile devices.

2. Discussion

In web development, a “mashup” can be a Web application that combines data from one or more sources into a single integrated tool. An example of a mashup could be the use of cartographic data from an online map service to add location information to real estate data, thereby creating a new and distinct Web service that was not originally provided by either source. Mashups today may typically be built using desktop-browser or thick client development environments—that is, conventional mashup building tools can require a browser with a large window or a desktop application with sufficient real estate to provide the user with a fairly large work area, a keyboard and a mouse. Traditionally, mobile devices, such as wireless smart phones or personal digital assistants (PDAs), simply have not had the screen real estate and functionality required to build mashups using the behaviors commonly in use on the desktop or in the browser.

### BRIEF SUMMARY

Embodiments may provide for a method in which mashup creation input is received via a touch screen of a mobile device. In one example, the mashup creation input includes a selection of one or more icons, wherein each icon is associated with a widget. A mashup can be built based on the mashup creation input, and the mashup may be presented to a user via the touch screen.

Embodiments can also include a computer program product having a computer readable storage medium and computer usable code stored on the computer readable storage medium. If executed by a processor, the computer usable code may cause a mobile device to display a plurality of icons in a palette on a touch screen of the mobile device, wherein each icon is to be associated with a widget. The computer usable code can also cause the mobile device to display a canvas region on the touch screen, and display a first icon in the canvas region in response to receipt of a request to drop the first icon into the canvas region. In addition, the computer usable code may cause the mobile device to display a second icon in the canvas region in response to receipt of a request to drop the second icon into the canvas region. The computer usable code can further detect a drop of the first icon onto the second icon and draw a visual connection between the first icon and the second icon. Moreover, the computer usable code may create a functional connection between a first widget associated with the first icon and a second widget associated with the second icon in response to the drop of the first icon onto the second icon. In one example, at least one of the first and second widgets are to include a native resource of the mobile device, and the native resource is to include at least one of a location awareness module, a presence module, a local address book, a local calendar and a social networking module. The computer usable code may also cause the mobile device to build a mashup based on the first and second widgets, and the functional connection. In addition, the computer usable code can cause the mobile device to present the mashup to a user via the touch screen.

Other embodiments may provide for a method in which a plurality of icons is displayed in a palette on a touch screen of a mobile device, wherein each icon is associated with a widget. A canvas region may also be displayed on the touch screen, wherein a first icon is displayed in the canvas region in response to receiving a request to drop the first icon into the canvas region. A second icon can be displayed in the canvas region in response to receiving a request to drop the second icon into the canvas region. In response to detecting a drop of the first icon onto the second icon, the method may include drawing a visual connection between the first icon and the second icon, and creating a functional connection between a first widget associated with the first icon and a second widget associated with the second icon. At least one of the first and second widgets can include a native resource of the mobile device, wherein the native resource includes at least one of a location awareness module, a presence module, a local address book, a local calendar and a social networking module. The method may also provide for building a mashup based on the first and second widgets, and the functional connection. In addition, the mashup can be presented to the user via the touch screen of the mobile device.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a flowchart of an example of a method of managing a mashup on a mobile device according to an embodiment;

FIG. 2 is a block diagram of an example of a mobile device architecture according to an embodiment;

FIG. 3 is a diagram of an example of a mobile device mashup construction user interface according to an embodiment;

FIG. 4 is a flowchart of an example of a method of building a mashup on a mobile device according to an embodiment;

FIG. 5 is a diagram of an example of a mobile device audible widget description output according to an embodiment;

FIG. 6 is a diagram of an example of a mobile device canvas drop user interface according to an embodiment;

FIGS. 7A and 7B are diagrams of examples of a mobile device widget connection user interface according to an embodiment; and

FIGS. 8A-8D are diagrams of examples of a mobile device mashup simulation user interface according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

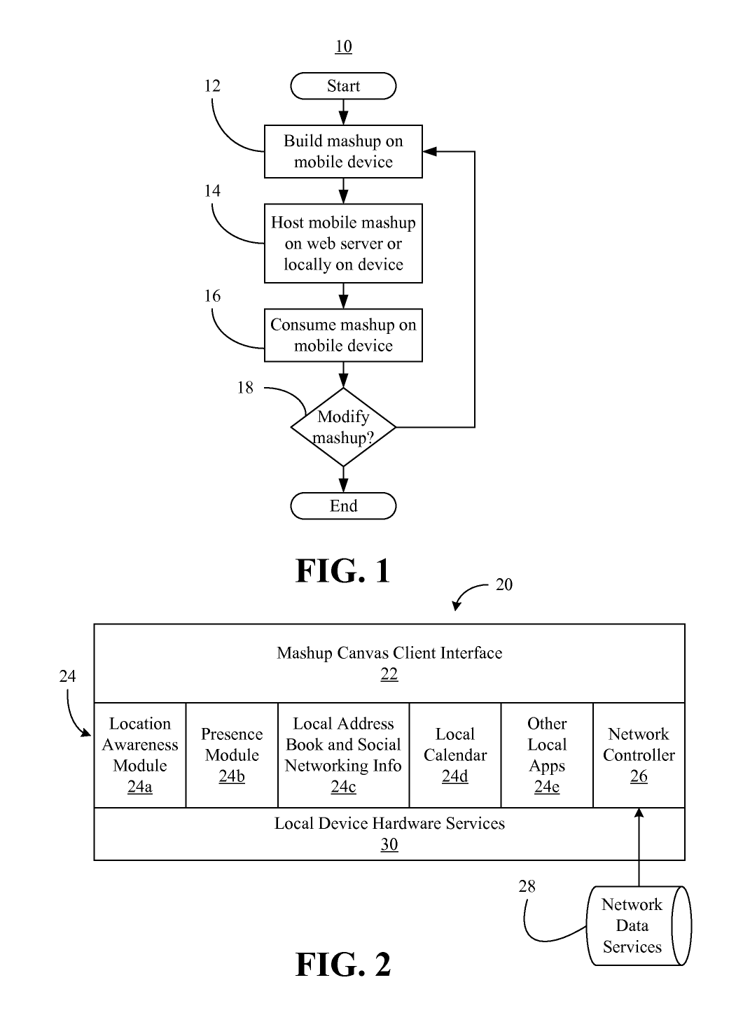

Referring now to FIG. 1, a method 10 of managing the creation and use of a mashup is shown. The method 10 could be implemented in executable software as a set of logic instructions stored in a machine- or computer-readable medium such as random access memory (RAM), read only memory (ROM), programmable ROM (PROM), flash memory, etc., as fixed-functionality hardware using circuit technology such as application specific integrated circuit (ASIC), complementary metal oxide semiconductor (CMOS) or transistor-transistor logic (TTL) technology, or any combination thereof.

Processing block 12 provides for building a mashup on a mobile device based on mashup creation input obtained via a user interface (UI) of the mobile device. As will be discussed in greater detail, the mobile device can include a touch screen-based UI that includes a widget palette and a canvas region. In addition, the mobile mashup can be hosted at block 14 either on a web server or locally on the mobile device. Block 16 provides for consumption of the mashup on the mobile device on which the mashup was built. Accordingly, many of the difficulties that might be encountered with mashups that are created on another platform and transformed into a mobile format may be avoided with the illustrated approach. If additional mashup creation input is detected at block 18, the process can be repeated.

FIG. 2 shows a mobile device architecture 20 having a plurality of device-specific resources 24 (24a-24e) and a network controller 26 residing between a mashup canvas client interface 22 and one or more local device hardware services 30. The network controller 26, which may function as an interface to remote widgets from network data services 28, might include wireless data functionality (e.g., IEEE 802.11, 1999 Edition, LAN/MAN Wireless LANS (WiFi), IEEE 802.16-2004, LAN/MAN Broadband Wireless LANS (WiMAX), etc.), cellular telephone functionality (e.g., W-CDMA (UMTS), CDMA2000 (IS-856/IS-2000), etc.), wired data functionality (e.g., RS-232 (Electronic Industries Alliance/EIA), Ethernet (e.g., IEEE 802.3-2005, LAN/MAN CSMA/CD Access Method), power line communication (e.g., X10, IEEE P1675), USB (e.g., Universal Serial Bus 2.0 Specification)), etc., depending upon the circumstances. In addition, the network(s) associated with the data services 28 can include any suitable combination of servers, access points, routers, base stations, mobile switching centers, public switching telephone network (PSTN) components, etc., to facilitate communication between the mobile device architecture 20 and the network data services 28.

Mashups created via the canvas client interface 22 can include widgets that incorporate the device-specific resources 24. A widget might include a set of data and/or executable functions that can be combined with other sets of data and/or functions to provide a new user-defined application that is beyond the scope of any of the underlying widgets. For example, widgets for maps, address books, location based services, e-commerce transactions, SMS (short message service), MMS (multimedia message service), etc., could all be incorporated into a mashup. In the illustrated example, the device-specific resources 24 include a variety of resources such as a location awareness module 24a, a user presence module 24b, a local address book and/or social networking module 24c, a local calendar 24d and other local applications 24e. The location awareness module 24a could include global positioning system (GPS) functionality, whereas the user presence module 24b might be used to determine whether a user of the mobile device is logged into a particular service such as a local device hardware service 30 or a network data service 28. The illustrated local address book and/or social networking module 24c provide for management of the user's contacts and social networking site (e.g., Facebook, LinkedIn) data. The device-specific resources 24 may therefore enable highly-customized mashups to be built on and for the mobile device, wherein simulation of the device-specific resources 24 during mashup construction is not required.

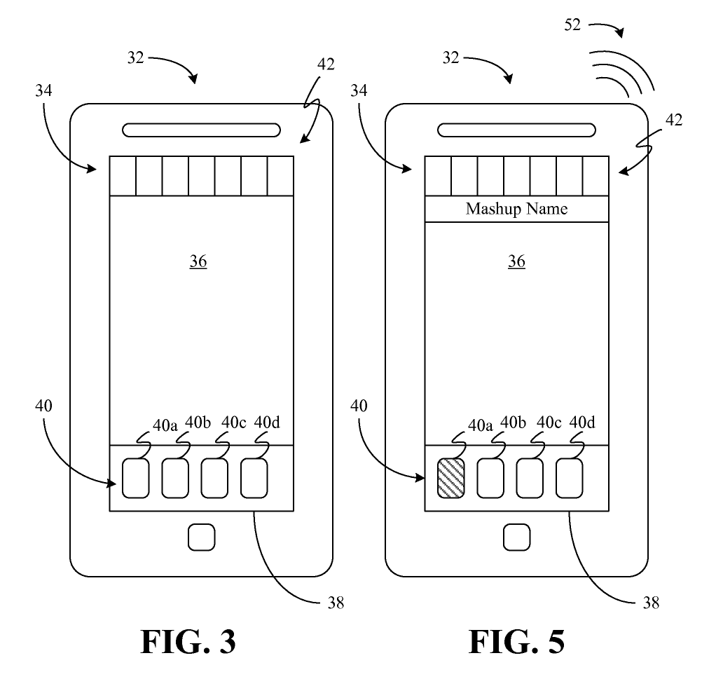

Turning now to FIG. 3, one example of a UI for building mashups on a touch screen 42 of a mobile device 32 is shown. In the illustrated example, a menu bar 34, a canvas region 36, and a scrolling palette 38 are displayed on the touch screen 42 of the mobile device 32, wherein the palette 38 includes a plurality of icons 40 (40a-40d) and each icon 40 is associated with a widget. The widgets could reside locally on the device 32 or be accessible from a network data service 28 (FIG. 2) or other remote location. The menu bar 34 may provide the user with various mashup management options to perform a wide variety of functions such as creating a new mashup, displaying a mashup, editing an existing mashup, saving a current mashup, and so on. Generally, the canvas region 36 can be used to select, drag, drop, and manipulate widgets when building mashups.

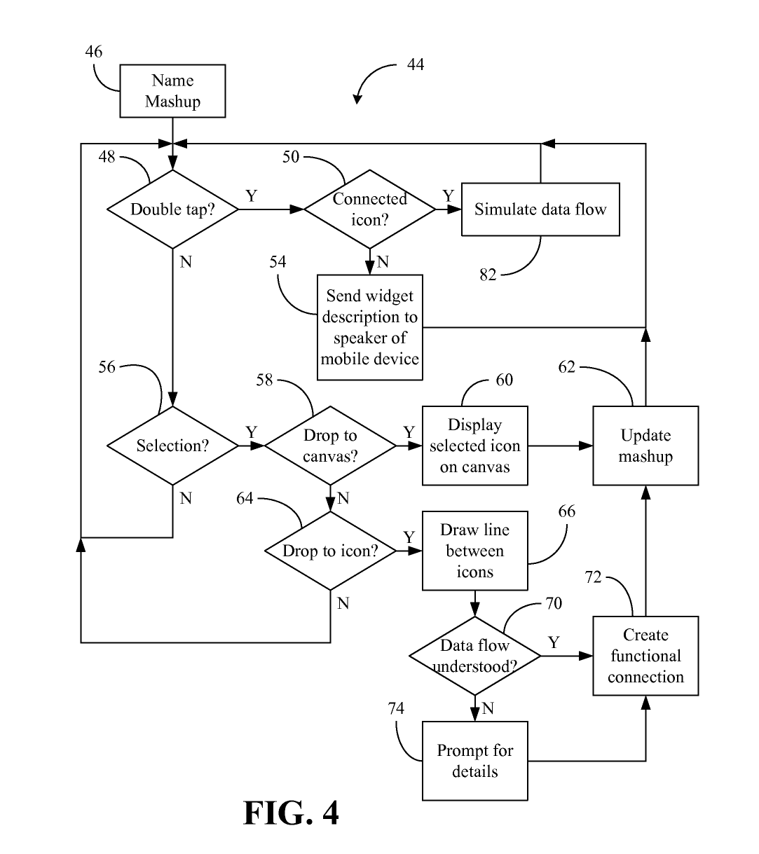

FIGS. 4 and 5 show a method 44 of creating a mashup in response to selection of a “new mashup” option from the menu bar 34. In the illustrated example, the user is prompted to name the mashup at block 46. If a double tap of an icon such as icon 40a is detected at block 48, a determination may be made at block 50 as to whether the widget associated with the selected icon 40a has a connection to another widget in the mashup. If not, a description of the widget associated with the selected icon can be transmitted at block 54 to a speaker (not shown) of the mobile device 32, which can generate an audible output 52 of the description. Thus, the user may scroll through the icons 40 in the palette 38 and determine which widgets to use by double tapping icons 40 and listening to the corresponding widget descriptions. The user might also listen to descriptions of widgets after their associated icons have been dropped into the canvas region 36.

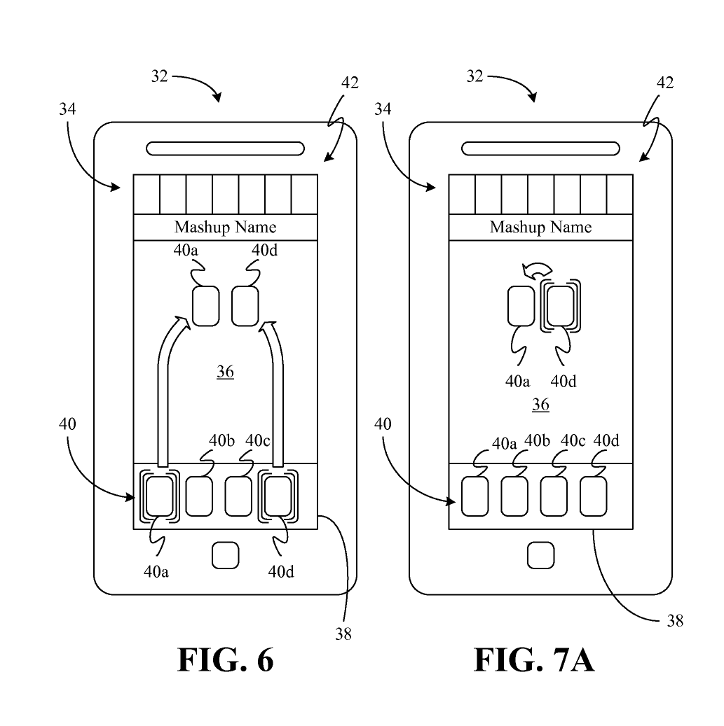

With continuing reference to FIGS. 4 and 6, the selection of widgets for a mashup is shown. In the illustrated example, block 56 provides for detecting a selection (e.g., tap and hold) of an icon, wherein if it is determined at block 58 that the selected icon has been dropped to the canvas region 36, block 60 provides for displaying the selected icon in the canvas region 36. Thus, a selection of icon 40a may involve tapping and holding the icon 40a, which may cause the selected icon 40a to vibrate. Such vibration can provide real-time visual and/or tactile feedback to the user that the selection has been made. In the illustrated example, icon 40d is also dragged and dropped into the canvas region 36. As will be discussed in greater detail, the icons 40 could also be transferred to the canvas region 36 by dropping them onto one another in the palette 38. Moving the icons 40a and 40d into the canvas region 36 could also cause a configuration dialog box (not shown) to be displayed. The widgets associated with the icons 40a and 40d might also be configured by selecting a configuration option from the menu bar 34. Block 62 provides for updating and/or saving the mashup based on the mashup creation input.

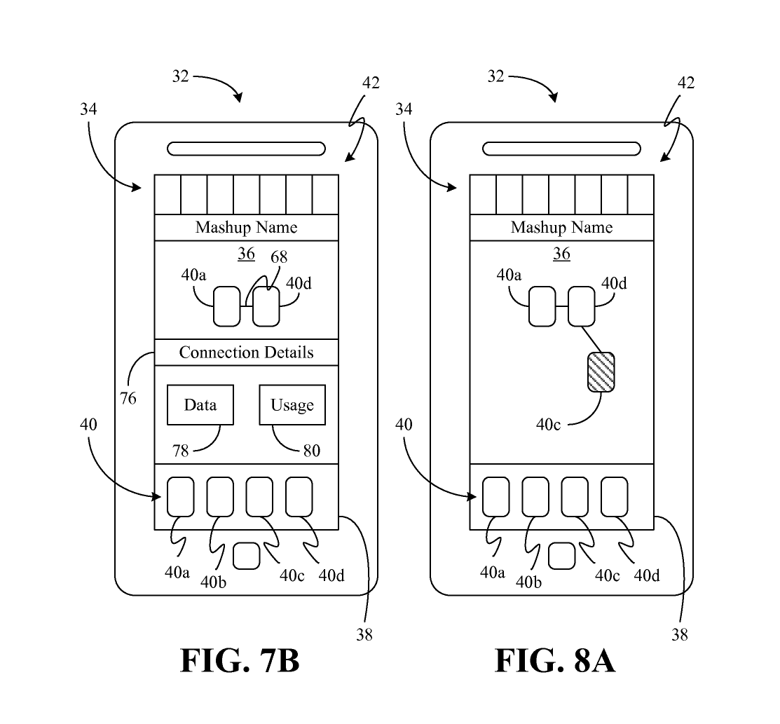

FIGS. 4, 7A and 7B demonstrate that users may create functional connections between widgets by dropping icons onto one another. In particular, if it is determined at block 58 that the drop of the selected icon is not to the canvas region 36, illustrated block 64 provides for determining whether the selected icon has been dropped to another icon in the canvas region 36. Thus, the user might select the icon 40d (causing it to vibrate) and drop the icon 40d onto icon 40a to create a connection between the widgets associated with the icons 40a and 40d. The method might also visually change the receiving icon 40a (e.g., turn the icon grey) while it is under the dragged icon 40d to indicate to the user that the corresponding widget can accept data from the dragged icon 40d prior to the user releasing his or her finger. Block 66 provides for drawing a visible connection such as a line 68 between the icons 40a and 40d involved in the icon drop operation. A similar approach to functionally connecting widgets could also be implemented in which icons 40 are dropped onto one another in the palette 38. In such a case, dropping an icon onto another icon might automatically pull both icons into the canvas region 36.

If it is determined at block 70 that the data flow between the widgets associated with the two icons 40a and 40d is understood (e.g., unambiguous), block 72 provides for creating a functional connection between the corresponding widgets. If clarification is needed, the user may be prompted at block 74 for details of the functional connection. In one example, a dialog box 76 is generated and displayed on the touch screen 42, wherein the illustrated dialog box 76 includes a data field 78 to enable the user to identify the data to flow between the widgets and a usage field 80 to enable the user to identify how the data is to be used upon receipt. The direction of the data can be inferred from the order in which icons are dropped on one another (e.g., dropped icon sends data to the icon beneath) and/or expressly configured in the details dialog box 76.

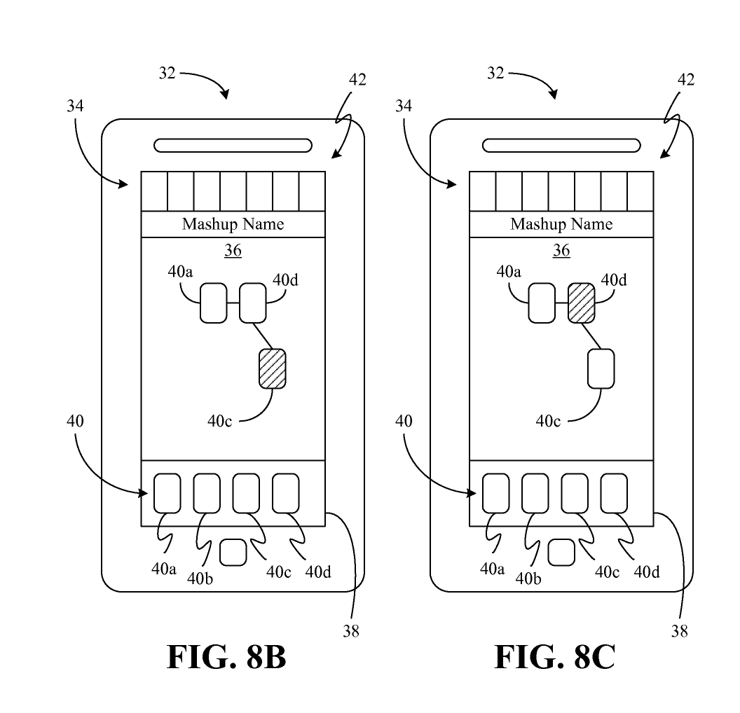

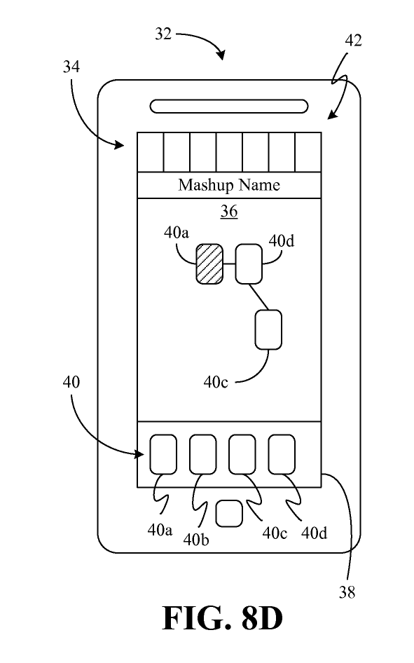

With continuing reference to FIGS. 4 and 8A-8D, one approach to enhancing the mashup building process is shown wherein the data flow of a mashup may be simulated via the touch screen 42. In particular, the illustrated mashup contains the functionally connected widgets associated with icons 40a, 40c and 40d. If it is determined at block 50 that a connected icon such as icon 40c has been double tapped, block 82 provides for simulating the data flow of the mashup containing the widget associated with the doubled tapped icon 40c. The simulation might involve sequentially modifying the appearance of the connected icon and one or more remaining icons in the mashup based on the data flow. In the example illustrated in FIGS. 8B-8D, the icons 40c, 40d and 40a are highlighted in sequence to animate the data flow in the mashup.

Thus, a user might name a mashup “Teammate Locations”, wherein icon 40a could be associated with a map widget, icon 40d may be associated with a GPS location widget, and icon 40c might be associated with an address book widget. The address book widget may use native content that is local to the device 32. At the beginning of the mashup building process, the user can select an option from the menu bar 34 to display the widget palette 38. A scrolling list of icons may then appear allowing the user to select the icon 40a associated with the map widget and drag the map widget icon 40a into the canvas region 36, as already discussed. The widget palette 38 could remain visible or disappear after the drop of the icon 40a into the canvas region 40a, depending upon the configuration.

The user may again select an option from the menu bar 34 to display the widget palette 38, and this time might drag and drop an address book widget icon 40c into the canvas region 36. The user could then tap the icon 40c in the canvas region 36 and select a configuration option from the menu bar 34, which may display configuration properties for the address book widget. For example, a multi-select list of people can be displayed, wherein the user selects the contacts who are to be included in the mashup. The settings may then be saved by pressing a save button/option in the menu bar 34. The configuration panel can then disappear and the canvas region 36 may be re-displayed with the map widget icon 40a and the newly customized address book widget icon 40c (utilizing address book content that is local to the device) contained therein.

The user could also open the widget palette 38 and drag a GPS location widget icon 40d onto the canvas region 36, wherein the GPS location widget interfaces with a host-based service that returns the known locations of individuals. To wire the three widgets together, the user presses and holds the address book widget icon 40c until it “wiggles” and then drags it over the GPS location widget icon 40d. As already noted, the GPS location widget icon 40d might grey or provide some other visual clue to indicate that it can accept the address book widget and then the user releases his or her finger to indicate that the two widgets are to be wired together. If the wiring is unambiguously understood by the GPS location widget, then the address book widget icon 40c may return to its previous location, but a line (e.g., “wire”) is now drawn between the two icons 40d and 40c. If the wiring is ambiguous, a dialog 76 (FIG. 7B) can be displayed with input fields and other controls enabling the user to specify what field or fields included in the data being sent to the GPS location widget are to be used by the GPS location widget to retrieve the locations of the individuals selected in the address book widget.

Similarly, the user may press and hold the GPS location widget icon 40d until it wiggles, drag it over the map widget icon 40a, and drop it to indicate that a functional connection is to be created between the GPS location widget and the map widget. If necessary, a configuration dialog could appear allowing the user to configure the connection. The user could also select the map widget icon 40a and then the configure button in the menu bar 34 to configure how location pins are to be plotted on the map, as well as what associated information should be displayed.

To review the flow of the mashup, the user might double tap the address book widget icon 40c, which then glows (e.g., FIG. 8B) and returns to normal, followed by a pause. The GPS location widget icon 40d may glow next (e.g., FIG. 8C), followed by the map widget icon 40a (e.g., FIG. 8D), and so on until the sequence is complete.

The user may save the mashup by selecting the save option in the menu bar 34. If the user then selects a “display” option from the menu bar 34, the illustrated canvas region 36 will be overlaid with the running mashup. In this case, the display would include a map containing pins representing each of the people selected in the user's address book widget. Upon selecting a person's pin, further information contained in the address book could be displayed. When the mashup builder is finally closed, a mashup icon may appear on the device's home page, wherein if the mashup icon is selected, a running version of the mashup can be displayed.

The above-described scenario could be extended to include additional widgets. For instance, a “Call” widget could be tied to the map widget, wherein pressing a person's pin (or other similar gesture) on the map initiates a call with the person. Moreover, a “Timer” widget could also be connected to the address book widget in order to force the mashup to refresh in periodic intervals.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. are used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer program product comprising:
a computer readable storage medium; and
computer usable code stored on the computer readable storage medium, where, if executed by a processor, the computer usable code causes a mobile device to:
display a plurality of icons in a palette on a touch screen of the mobile device, wherein each icon is to be associated with a widget;
display a canvas region on the touch screen;
display a first icon in the canvas region in response to receipt of a request to drop the first icon into the canvas region;
display a second icon in the canvas region in response to receipt of a request to drop the second icon into the canvas region;
detect a drop of the first icon onto the second icon;
create a functional connection between a first widget associated with the first icon and a second widget associated with the second icon in response to the drop of the first icon onto the second icon;
build a mashup based on the first and second widgets, and the functional connection; and
present the mashup via the touch screen.

2. The computer program product of claim 1, wherein dropping the first icon onto the second icon invokes a visual connection between the first icon and the second icon.

3. The computer program product of claim 1, wherein at least one of the first and second widgets are to include a native resource of the mobile device, and the native resource is to include at least one of a location awareness module, a presence module, a local address book, a local calendar and a social networking module.

4. The computer program product of claim 1, wherein the computer usable code, if executed, further cause the mobile device to prompt for details of the functional connection, wherein the details are to include an identification of data to flow between the first and second widgets, and an identification of how the data is to be used upon receipt.

5. The computer program product of claim 1, wherein the computer usable code, if executed, further causes the mobile device to:
detect a double tap of a connected icon in the mashup; and
sequentially modify an appearance of the connected icon and one or more remaining icons in the mashup based on a data flow of the mashup.

6. The computer program product of claim 1, wherein the computer usable code, if executed, further causes the mobile device to:
detect a double tap of an icon; and
generate an audible description of the double tapped icon.

7. The computer program product of claim 1, wherein the computer usable code, if executed, further causes the mobile device to obtain at least one of the widgets via a network interface of the mobile device.

8. A method comprising:
displaying a plurality of icons in a palette on a touch screen of a mobile device, wherein each icon is associated with a widget;
displaying a canvas region on the touch screen;
displaying a first icon in the canvas region in response to receiving a request to drop the first icon into the canvas region;
displaying a second icon in the canvas region in response to a drop of the second icon into the canvas region;
detecting a drop of the first icon onto the second icon;
creating a functional connection between a first widget associated with the first icon and a second widget associated with the second icon in response to the drop of the first icon onto the second icon;
building a mashup based on the first and second widgets, and the functional connection; and
presenting the mashup via the touch screen.

9. The method of claim 8, wherein dropping the first icon onto the second icon invokes a visual connection between the first icon and the second icon.

10. The method of claim 8, wherein at least one of the first and second widgets includes a native resource of the mobile device, and the native resource includes at least one of a location awareness module, a presence module, a local address book, a local calendar and a social networking module.

11. The method of claim 8, further including prompting for details of the functional connection, wherein the details include an identification of data to flow between the first and second widgets, and an identification of how the data is to be used upon receipt.

12. The method of claim 8, further including:
detecting a double tap of a connected icon in the mashup; and
sequentially modifying an appearance of the connected icon and one or more remaining icons in the mashup based on a data flow of the mashup.

13. The method of claim 8, further including:
detecting a double tap of an icon; and
generating an audible description of the double tapped icon.

14. The method of claim 8, further including obtaining at least one of the widgets via a network interface of the mobile device.

15. A method comprising:
receiving a mashup creation input via a touch screen of a mobile device;
building a mashup based on the mashup creation input; and
presenting the mashup via the touch screen, wherein the mashup creation input includes a selection of an icon associated with a widget.

16. The method of claim 15, wherein the mashup creation input further includes a drop of a first icon onto a second icon and building the mashup includes:
drawing a visual connection between the first icon and the second icon; and
creating a functional connection between a first widget associated with the first icon and a second widget associated with the second icon.

17. The method of claim 15, further including prompting for details of the functional connection, wherein the details include an identification of data to flow between the first and second widgets, and an identification of how the data is to be used upon receipt.

18. The method of claim 15, further including simulating a data flow of the mashup via the touch screen.

19. The method of claim 18, wherein simulating the data flow includes:
detecting a double tap of a connected icon in the mashup; and
sequentially modifying an appearance of the connected icon and one or more remaining icons in the mashup based on the data flow.

20. The method of claim 15, wherein the mashup creation input includes a double tap of the icon and the method further includes transmitting a description of the widget to a speaker of the mobile device.

21. The method of claim 15, wherein the widget includes a native resource of the mobile device.

22. The method of claim 21, wherein the native resource includes at least one of a location awareness module, a presence module, a local address book, a local calendar and a social networking module.

23. The method of claim 15, further including obtaining the widget via a network interface of the mobile device.

24. The method of claim 15, further including:
displaying a plurality of icons in a palette on the touch screen, wherein each icon is associated with a widget; and
displaying a canvas region on the touch screen, wherein the canvas region contains one or more of the plurality of icons.
